(19) United States
(12) Patent Application Publication
(10) Pub. No.: US 2023/0159749 A1
(43) Pub. Date: May 25, 2023

(54) STRETCHABLE ELECTROCONDUCTIVE MATERIAL, METHOD FOR MANUFACTURING THE SAME, AND DEVICE USING THE STRETCHABLE ELECTROCONDUCTIVE MATERIAL

(71) Applicant: Zhen Ding Technology Co., Ltd., Tayuan (TW)

(72) Inventors: SHENG-FENG CHUNG, Tayuan (TW); CHI-FEI HUANG, Tayuan (TW)

(21) Appl. No.: 17/536,305

(22) Filed: Nov. 29, 2021

(30) Foreign Application Priority Data
Nov. 25, 2021 (CN) 202111414194.6

(51) Int. Cl. C08L 71/02; H01B 1/24

(52) U.S. Cl. CPC C08L 71/02; H01B 1/24; C08L 2205/06; C08L 2203/20

(57) ABSTRACT

A stretchable electroconductive material includes 100 parts by weight of PEDOT-PSS, 200 parts to 1000 parts by weight of a repair linking agent, 15 parts to 300 parts by weight of an ionic liquid plasticizer, and 15 parts to 200 parts by weight of carbon material particles. The repair linking agent is selected from a group consisting of polyethylene glycol and polyethylene oxide, and any combination thereof. The repair linking agent, the ionic liquid plasticizer, and the carbon material particles are doped in the PEDOT-PSS. A method for manufacturing the stretchable electroconductive material and a device using the stretchable electroconductive material are also provided.

### FIELD

The subject matter herein generally relates to a deformable material, in particular to a stretchable electroconductive material, a method for manufacturing the stretchable electroconductive material, and a device using the stretchable electroconductive material.

### BACKGROUND

Stretchable electroconductive materials are widely used in various fields, such as flexible (retractable) electronics, wearable devices, implantable components, artificial prostheses, intelligent robots, and various irregular surfaces that require conductive properties. However, the self-repairing ability of the stretchable electroconductive material cannot satisfy the demand of new products.

Therefore, there is room for improvement within the art.

### BRIEF DESCRIPTION OF THE DRAWINGS

Implementations of the present technology will now be described, by way of example only, with reference to the attached figures.

FIG. 1 is a flowchart of an embodiment of a method for manufacturing a stretchable electroconductive material.

FIG. 2 is a diagram of an embodiment of a device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

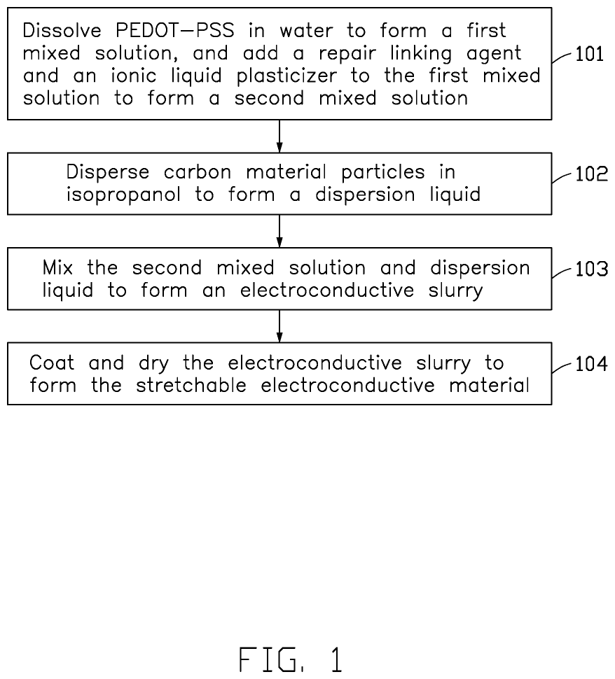

FIG. 1 illustrates a flowchart of a method in accordance with an embodiment. The method for manufacturing a stretchable electroconductive material is provided by way of embodiments, as there are a variety of ways to carry out the method. Each block shown in FIG. 1 represents one or more processes, methods, or subroutines carried out in the method. Furthermore, the illustrated order of blocks can be changed. Additional blocks may be added or fewer blocks may be utilized, without departing from this disclosure. The method can begin at block 101.

At block 101, poly(3,4-ethylenedioxythiophene)-poly(styrenesulfonate) (shorted as PEDOT-PSS) is dissolved in water to form a first mixed solution, and then a repair linking agent and an ionic liquid plasticizer are sequentially added to the first mixed solution to form a second mixed solution. The repair linking agent is selected from a group consisting of polyethylene glycol (PEG) and polyethylene oxide (PEO), and any combination thereof.

In the second mixed solution, the PEDOT-PSS is 100 parts by weight, the repair linking agent is 200 parts to 1000 parts by weight, the ionic liquid plasticizer is 15 parts to 300 parts by weight.

In at least one embodiment, a content of water only needs to dissolve the PEDOT-PSS, the repair linking agent, and the ionic liquid plasticizer, which is not limited here.

Preferably, the molecular weight of the polyethylene glycol may be 100 to 500. The molecular weight of the polyethylene oxide may be 50000 to 150000. More preferably, the molecular weight of the polyethylene glycol is 100 to 400. The molecular weight of the polyethylene oxide is 80000 to 120000, so as to further improve a self-repairing ability of the stretchable electroconductive material.

The ionic liquid plasticizer may be selected from a group consisting of 1-ethyl-3-methylimidazolium tetracyanoborate, bis(trifluoromethane) sulfonamide lithium salt, 1-butyl-3-methylimidazolium octyl sulfate, dioctyl sulfosuccunate sodium salts, sodium dodecylbenzenesulfonate, and any combination thereof.

In at least one embodiment, the PEDOT-PSS, the repair linking agent, and the ionic liquid plasticizer may be mixed by stirring. A rate of the stirring may be in a range of 600 rpm to 1500 rpm. A time of the stirring may in a range of 10 hours to 14 hours.

At block 102, carbon material particles are dispersed in isopropanol to form a dispersion liquid.

The carbon material particles may include a group consisting of carbon nanotubes and graphene, and any combination thereof. Preferably, an aspect ratio of each of the carbon nanotubes may be in a range of 100:1 to 1000:1. More preferably, the aspect ratio of each of the carbon nanotubes is 500:1 to 700:1.

In at least one embodiment, a diameter of each of the carbon nanotubes may be preferably in a range of 45 nm to 55 nm. A length of each of the carbon nanotubes may be preferably in a range of 27 μm to 33 μm.

The number of layers of the graphene may be preferably in a range of 5 to 15. A thickness of the graphene may be preferably in a range of 2 nm to 5 nm, and a specific surface area of the graphene may be preferably in a range of 80 m²/g to 150 m²/g.

In at least one embodiment, a mass percentage of the carbon material particles in the dispersion liquid may be 0.5% to 5%.

In at least one embodiment, the carbon material particles may be added to the isopropanol for stirring and then ultrasonic oscillation to obtain the dispersion liquid. A rate of the stirring to obtain the dispersion liquid may be in a range of 600 rpm to 1500 rpm, a time of the stirring to obtain the dispersion liquid may be in a range of 2 hours to 4 hours. A frequency of the ultrasonic oscillation may be in a range of 10 kHz to 50 kHz. A time of the ultrasonic oscillation may be in a range of 30 min to 90 min.

At block 103, the second mixed solution and dispersion liquid are mixed to form an electroconductive slurry. In the electroconductive slurry, a weight ratio of the carbon material particles to the PEDOT-PSS is in a range of 3:20 to 2:1.

In at least one embodiment, the second mixed solution and dispersion liquid are mixed by stirring and ultrasonic oscillation sequentially to obtain the electroconductive slurry. A rate of the stirring to obtain the electroconductive slurry may be in a range of 600 rpm to 1500 rpm, a time of the stirring to obtain the electroconductive slurry may be in a range of 2 hours to 4 hours. A frequency of the ultrasonic oscillation to obtain the electroconductive slurry may be in a range of 10 kHz to 50 kHz. A time of the ultrasonic oscillation to obtain the electroconductive slurry may be in a range of 30 min to 90 min.

In at least one embodiment, a viscosity of the electroconductive slurry may be 50 cps to 1000 cps.

At block 104, the electroconductive slurry is coated and dried to form the stretchable electroconductive material.

The coated electroconductive slurry may be dried at a temperature of 60 degree Celsius to 140 degree Celsius for 90 min to 120 min. In at least one embodiment, the time to dry the coated electroconductive slurry may be adjusted according to a thickness of the coated electroconductive slurry.

In at least one embodiment, the coated electroconductive slurry may be preferably dried by increasing the temperature periodically. More preferably, the coated electroconductive slurry may be kept at a temperature of 60 degree Celsius for 30 min to slowly volatilize the isopropanol and the water in the coated electroconductive slurry, then kept at a temperature of 90 degree Celsius for 30 min to thoroughly remove the isopropanol and the water in the coated electroconductive slurry, and finally kept at 140 degree Celsius for 30 min to 60 min, so that the polymer in the coated electroconductive slurry reacts to form a film having a stable structure, thereby obtaining the stretchable electroconductive material.

In the above method, the PEDOT-PSS is used as the main electroconductive medium of the prepared stretchable electroconductive material to conduct electricity. The ionic liquid plasticizer is doped into the PEDOT-PSS to improve the electroconductivity of the PEDOT-PSS. At the same time, when preparing the stretchable electroconductive material, the arrangement of the PEDOT-PSS may be changed by the ionic liquid plasticizer to achieve a toughening effect, thereby improving a stretchability of the stretchable electroconductive material. The repair linking agent may further improve the electroconductivity and mechanical properties of the stretchable electroconductive material. The stretchable electroconductive material realizes reversible dynamic bonding by introducing the repair linking agent into the PEDOT-PSS, so that the stretchable electroconductive material has a self-repairing performance. The second mixed solution and the dispersion liquid are prepared separately first, and then the second mixed solution and the dispersion liquid are mixed, which is conducive to the PEDOT-PSS and the carbon material particles to be doped and dispersed with each other.

An embodiment of a stretchable electroconductive material includes 100 parts by weight of poly(3,4-ethylenedioxythiophene)-poly(styrenesulfonate) (shorted as PEDOT-PSS), 200 parts to 1000 parts by weight of a repair linking agent, 15 parts to 300 parts by weight of an ionic liquid plasticizer, and 15 parts to 200 parts by weight of carbon material particles. The repair linking agent, the ionic liquid plasticizer, and the carbon material particles are doped in the PEDOT-PSS.

The repair linking agent is selected from a group consisting of polyethylene glycol (PEG) and polyethylene oxide (PEO), and any combination thereof. Preferably, the molecular weight of the polyethylene glycol may be 100 to 500. The molecular weight of the polyethylene oxide may be 50000 to 150000. More preferably, the molecular weight of the polyethylene glycol is 100 to 400. The molecular weight of the polyethylene oxide is 80000 to 120000.

The ionic liquid plasticizer may be selected from a group consisting of 1-ethyl-3-methylimidazolium tetracyanoborate, bis(trifluoromethane) sulfonamide lithium salt, 1-butyl-3-methylimidazolium octyl sulfate, dioctyl sulfosuccunate sodium salts, sodium dodecylbenzenesulfonate, and any combination thereof.

The carbon material particles may include a group consisting of carbon nanotubes and graphene, and any combination thereof. Preferably, an aspect ratio of each of the carbon nanotubes may be in a range of 100:1 to 1000:1. More preferably, the aspect ratio of each of the carbon nanotubes is 500:1 to 700:1.

In at least one embodiment, a diameter of each of the carbon nanotubes may be preferably in a range of 45 nm to 55 nm. A length of each of the carbon nanotubes may be preferably in a range of 27 μm to 33 μm.

The number of layers of the graphene may be preferably in a range of 5 to 15. A thickness of the graphene may be preferably in a range of 2 nm to 5 nm, and a specific surface area of the graphene may be preferably in a range of 80 m²/g to 150 m²/g.

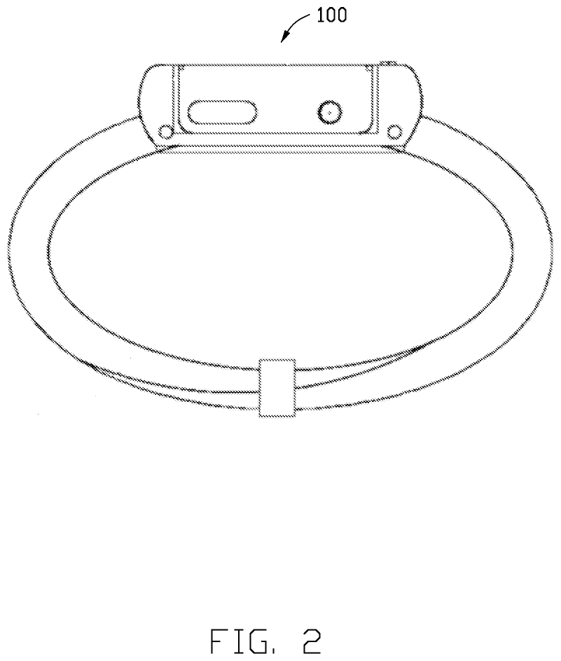

The stretchable electroconductive material may be applied in a device (shown in FIG. 2). The device may be, but is not limited to, a wearable device, an artificial prosthesis, an intelligent robot, and so on.

### EXAMPLE 1

100 g of PEDOT-PSS was dissolved in 9300 g of water to form a first mixed solution, then 600 g of PEG and 150 g of 1-ethyl-3-methylimidazolium tetracyanoborate were sequentially added to the first mixed solution and stirred at a rate of 800 rpm for 12 hours, thereby obtaining a second mixed solution.

50 g of carbon nanotubes were dispersed in 5000 g of isopropanol, stirred at a rate of 800 rpm for 3 hours, and then ultrasonic oscillated at a frequency of 20 kHz for 1 hour, thereby obtaining a dispersion liquid.

The second mixed solution and the dispersion liquid were mixed, stirred at a rate of 800 rpm for 3 hours, and then ultrasonic oscillated at a frequency of 20 kHz for 1 hour, thereby obtaining an electroconductive slurry.

The electroconductive slurry was coated on a substrate, kept at a temperature of 60 degree Celsius for 30 min, then kept at a temperature of 90 degree Celsius for 30 min, and finally kept at 140 degree Celsius for 60 min, thereby obtaining an electroconductive film. A thickness of the electroconductive film was 20 μm.

### EXAMPLE 2

It was the same as the preparation method of example 1, except a mass of 1-ethyl-3-methylimidazolium tetracyanoborate of example 2 was 15 g.

### EXAMPLE 3

It was the same as the preparation method of example 1, except a mass of carbon nanotubes of example 3 was 15 g.

### EXAMPLE 4

It was the same as the preparation method of example 1, except a mass of carbon nanotubes of example 4 was 150 g.

### COMPARATIVE EXAMPLE 1

It was the same as the preparation method of example 1, except a mass of PEG of comparative example 1 was 150 g.

### COMPARATIVE EXAMPLE 2

100 g of PEDOT-PSS was dissolved in 9300 g of water to form a slurry. The slurry was coated on a substrate, kept at a temperature of 60 degree Celsius for 30 min, then kept at a temperature of 90 degree Celsius for 30 min, and finally kept at 140 degree Celsius for 60 min, thereby obtaining an electroconductive film. A thickness of the electroconductive film was 20 μm.

### COMPARATIVE EXAMPLE 3

100 g of PEDOT-PSS was dissolved in 9300 g of water to form a first mixed solution, then 600 g of PEG and 150 g of 1-ethyl-3-methylimidazolium tetracyanoborate were sequentially added to the first mixed solution and stirred at a rate of 800 rpm for 12 hours, thereby obtaining a second mixed solution.

The second mixed solution was coated on a substrate, kept at a temperature of 60 degree Celsius for 30 min, then kept at a temperature of 90 degree Celsius for 30 min, and finally kept at 140 degree Celsius for 60 min, thereby obtaining an electroconductive film. A thickness of the electroconductive film was 20 μm.

Initial wire resistance of four types of the electroconductive films prepared in examples 1 to 4 and three types of the electroconductive films prepared in the comparative examples 1 to 3 were respectively tested. The test results were shown in the following Table 1. Then the above seven types of the electroconductive films were respectively stretched 500 times, and each electroconductive film was stretched by 10% each time. Finally, wire resistance of the seven types of the electroconductive films after 500 times of stretching were respectively tested. The test results were shown in the following Table 1. At the same time, a rate of change of wire resistance after 500 times of stretching were calculated and shown in the following Table 1.

In addition, four types of the electroconductive films prepared in examples 1 to 4 and three types of the electroconductive films prepared in the comparative examples 1 to 3 were taken to test for self-repairing ability. The test results were shown in the following Table 1. The test method is as follows: first step, fixing opposite ends of each electroconductive film; second step, stretching the electroconductive film 100%, and then stretching the electroconductive film again 100% after the electroconductive film recovery; and third step, cycling the second step 500 times. If the electroconductive film cannot be recovered after 500 cycles or during the process, the electroconductive film cannot repair itself. If the electroconductive film can be recovered after 500 cycles, the electroconductive film can repair itself.

TABLE 1

| | Ex l | Ex 2 | Ex 3 | Ex 4 | Co-ex 1 | Co-ex 2 | Co-ex 3 |
|---|---|---|---|---|---|---|---|
| Initial wire | 150 | 150 | 195 | 130 | 155 | 200 | 200 |
| resistance | | | | | | | |
| (Ω/sq) | | | | | | | |
| wire | 185 | 460 | 235 | 176 | 196 | 1750 | 235 |
| resistance | | | | | | | |
| after | | | | | | | |
| stretching | | | | | | | |
| (Ω/sq) | | | | | | | |
| a rate of | 23.3% | 206% | 20.5% | 35.3% | 26.4% | 775% | 17.5% |
| change of | | | | | | | |
| wire | | | | | | | |
| resistance | | | | | | | |
| self-repairing | can repair | can repair | can repair | can repair | cannot | cannot | can repair |
| ability | itself | itself | itself | itself | repair | repair | itself |
| | | | | | itself | itself | |

According to the Table 1, the electroconductive films corresponding Ex 1 to 4 had good electroconductivity and good stretchability, and at the same time had self-repairing ability. If the content of the repair linking agent was too low, the ability of the electroconductive film to form hydrogen bonds is reduced, which in turn leads to a reduction in the self-repairing ability of the electroconductive film, the electroconductive film cannot be self-repaired.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

1. A method manufacturing a stretchable electroconductive material comprising:
dissolving 100 parts by weight of PEDOT-PSS in water to form a first mixed solution;
adding 200 parts to 1000 parts by weight of a repair linking agent and 15 parts to 300 parts by weight of an ionic liquid plasticizer sequentially to the first mixed solution to form a second mixed solution, wherein the repair linking agent is selected from a group consisting of polyethylene glycol and polyethylene oxide, and any combination thereof;
dispersing carbon material particles in isopropanol to form a dispersion liquid;
mixing the second mixed solution and dispersion liquid to form an electroconductive slurry, wherein in the electroconductive slurry, a weight ratio of the carbon material particles to the PEDOT-PSS is in a range of 3:20 to 2:1; and
coating and drying the electroconductive slurry to form the stretchable electroconductive material.

2. The method of claim 1, wherein the molecular weight of the polyethylene glycol is 100 to 500, and the molecular weight of the polyethylene oxide is 50000 to 150000.

3. The method of claim 1, wherein the ionic liquid plasticizer is selected from a group consisting of 1-ethyl-3-methylimidazolium tetracyanoborate, bis(trifluoromethane) sulfonamide lithium salt, 1-butyl-3-methylimidazolium octyl sulfate, dioctyl sulfosuccunate sodium salts, sodium dodecylbenzenesulfonate, and any combination thereof.

4. The method of claim 1, wherein the carbon material particles comprise a group consisting of carbon nanotubes and graphene, and any combination thereof.

5. The method of claim 4, wherein an aspect ratio of each of the carbon nanotubes is in a range of 100:1 to 1000:1, a diameter of each of the carbon nanotubes is in a range of 45 nm to 55 nm.

6. The method of claim 4, wherein the number of layers of the graphene is in a range of 5 to 15, a thickness of the graphene is in a range of 2 nm to 5 nm, and a specific surface area of the graphene is in a range of 80 m²/g to 150 m²/g.

7. The method of claim 1, wherein a mass percentage of the carbon material particles in the dispersion liquid is 0.5% to 5%.

8. The method of claim 1, wherein the electroconductive slurry is dried at a temperature of 60 degree Celsius to 140 degree Celsius for 90 min to 120 min.

9. The method of claim 8, wherein the electroconductive slurry is kept at a temperature of 60 degree Celsius for 30 min, then kept at a temperature of 90 degree Celsius for 30 min, and finally kept at 140 degree Celsius for 30 min to 60 min to be dried.

10. A stretchable electroconductive material comprising:
100 parts by weight of PEDOT-PSS;
200 parts to 1000 parts by weight of a repair linking agent;
15 parts to 300 parts by weight of an ionic liquid plasticizer; and
15 parts to 200 parts by weight of carbon material particles;
wherein the repair linking agent is selected from a group consisting of polyethylene glycol and polyethylene oxide, and any combination thereof, the repair linking agent, the ionic liquid plasticizer, and the carbon material particles are doped in the PEDOT-PSS.

11. The stretchable electroconductive material of claim 10, wherein the molecular weight of the polyethylene glycol is 100 to 500, and the molecular weight of the polyethylene oxide is 50000 to 150000.

12. The stretchable electroconductive material of claim 10, wherein the ionic liquid plasticizer is selected from a group consisting of 1-ethyl-3-methylimidazolium tetracyanoborate, bis(trifluoromethane) sulfonamide lithium salt, 1-butyl-3-methylimidazolium octyl sulfate, dioctyl sulfosuccunate sodium salts, sodium dodecylbenzenesulfonate, and any combination thereof.

13. The stretchable electroconductive material of claim 10, wherein the carbon material particles comprise a group consisting of carbon nanotubes and graphene, and any combination thereof.

14. The stretchable electroconductive material of claim 13, wherein an aspect ratio of each of the carbon nanotubes is in a range of 100:1 to 1000:1, a diameter of each of the carbon nanotubes is in a range of 45 nm to 55 nm.

15. The stretchable electroconductive material of claim 13, wherein the number of layers of the graphene is in a range of 5 to 15, a thickness of the graphene is in a range of 2 nm to 5 nm, and a specific surface area of the graphene is in a range of 80 m²/g to 150 m²/g.

16. A device comprising a stretchable electroconductive material, the stretchable electroconductive material comprising:
100 parts by weight of PEDOT-PSS;
200 parts to 1000 parts by weight of a repair linking agent;
15 parts to 300 parts by weight of an ionic liquid plasticizer; and
15 parts to 200 parts by weight of carbon material particles
wherein the repair linking agent is selected from a group consisting of polyethylene glycol and polyethylene oxide, and any combination thereof, the repair linking agent, the ionic liquid plasticizer, and the carbon material particles are doped in the PEDOT-PSS.

17. The device of claim 16, wherein the molecular weight of the polyethylene glycol is 100 to 500, and the molecular weight of the polyethylene oxide is 50000 to 150000.

18. The device of claim 16, wherein the ionic liquid plasticizer is selected from a group consisting of 1-ethyl-3-methylimidazolium tetracyanoborate, bis(trifluoromethane) sulfonamide lithium salt, 1-butyl-3-methylimidazolium octyl sulfate, dioctyl sulfosuccunate sodium salts, sodium dodecylbenzenesulfonate, and any combination thereof.

19. The device of claim 16, wherein the carbon material particles comprise a group consisting of carbon nanotubes and graphene, and any combination thereof.

20. The device of claim 19, wherein the an aspect ratio of each of the carbon nanotubes is in a range of 100:1 to 1000:1, a diameter of each of the carbon nanotubes is in a range of 45 nm to 55 nm; the number of layers of the graphene is in a range of 5 to 15, a thickness of the graphene is in a range of 2 nm to 5 nm, and a specific surface area of the graphene is in a range of 80 m²/g to 150 m²/g.
